(19) United States
(12) Patent Application Publication
(10) Pub. No.: US 2004/0111287 A1
(43) Pub. Date: Jun. 10, 2004

(54) Method and system of recycling cigarette butts and other small litter items

(76) Inventor: Jaswir Singh, Fresno, CA (US)

Correspondence Address: Richard A. Ryan, RYAN & ENGNATH, Suite 104, 8469 N. Millbrook, Fresno, CA, 93720, US

(21) Appl. No.: 10/622,962

(22) Filed: Jul. 17, 2003

Related U.S. Application Data
(63) Continuation-in-part of application No. 10/315,495, filed on Dec. 10, 2002.

(51) Int. Cl. G06F 17/60

(52) U.S. Cl. 705/1

(57) ABSTRACT

A method and system for recycling of cigarette butts and other small litter items that utilizes a recycling device which is provided with the sale of products having non-consumable portions, such as cigarettes with cigarette filters. The product manufacturer can attach or insert the recycling device to or in the product packaging. A retailer includes the recycling device with the sale of the product at no additional cost to the consumer. The recycling device includes a refund value amount that reduces the price of future product purchases. The consumer places non-consumed portions of the product, such as cigarette butts, inside the recycling device and presents it to the retailer to obtain the discounted price. The retailer collects and stores the recycling devices for subsequent collection by or delivery to a recycling facility. The method and system encourage recycling and reduce littering of small non-consumable items.

### CROSS-REFERENCE TO RELATED APPLICATIONS

This application is a continuation-in-part of co-pending U.S. patent application Ser. No. 10/315,495 filed Dec. 10, 2002.

### BACKGROUND OF THE INVENTION

A. Field of the Invention

The field of the present invention relates generally to methods and systems of recycling cigarette butts and other small litter items, such as gum wrappers, bottle tops, batteries and the like. More particularly, the present invention relates to methods and systems that are suitable to collecting, handling and processing small items for recycling purposes that would otherwise be ineffective, unsanitary, hazardous, burdensome or uneconomical due to their small size, weight and other inherent characteristics.

B. Background

Many products have a component or portion which is consumed by the consumer and a component or portion which is not consumed, such as the product wrapping material and the like. Generally, the non-consumed portions are disposed of as refuse. Although some of the refuse is taken to facilities for recycling, much of it ends up in landfills, incinerators and other non-recycling means of disposal, some of these non-consumed portions end up as litter. While larger non-consumed portions are more unsightly as litter and generally create a larger mess, they can be easier to collect than the relatively small non-consumed portions that end up as litter. Presently, the typical small, non-consumed product component is collected, if collected at all, with other larger items of refuse. Often, they are merely discarded on the ground by the consumer. Even when collected and placed in landfills, the smaller non-consumed items become litter problems due to their size and other factors. Because there is no presently available process for specifically collecting small non-consumable items that would otherwise be suitable for recycling, unlike aluminum cans and the like, these items are not collected and processed in a manner that facilitates their recycling. Collectively, items such as gum wrapping, bottle caps, batteries and other small, non-consumable product components represent a large amount of material.

One of the most common products having a non-consumable portion is cigarettes. In fact, it is believed that sales of individual cigarettes may be one of the most, if not the most, widely sold consumer product in the world. It is well known that, with regard to the vast majority of cigarettes, the smoker does not consume the entire cigarette during the process of smoking. Generally, the smoker lights and then smokes the consumable tobacco portion of the cigarette by inhaling the lit tobacco through the non-consumable filter portion of the cigarette. When the smoker is finished smoking the cigarette, which may be before the consumable portion is entirely consumed, a non-consumed portion of the cigarette remains (i.e., the filter and any remaining tobacco and wrapping material). The non-consumed portion of the cigarette is commonly referred to as the cigarette butt. Because the butt portion of the cigarette is not consumed during the smoking process, the user must dispose of the butt.

The proliferation of cigarette butts being disposed in improper places is well known, indicating the severity of the problem of being able to find a proper disposal location. Although most smokers will dispose of a cigarette butt in an ashtray or like device if it is readily available, such as an automobile ashtray, the problem of disposal arises when such devices are not readily available, resulting in the smoker being faced with the dilemma of where to safely and properly dispose of the butt. Because the butt was lit and is subject to breaking apart and spreading ash and cigarette “charcoal,” smokers tend to not want to place the butt in a pocket of their pants, shirt, jacket or other clothing. Likewise, many smokers are concerned with throwing a cigarette butt, even if believed to be properly extinguished, in a combustible trash container or a trash container having other combustible materials therein. As such, many smokers consider it to be safer and more convenient to simply drop or throw the cigarette butt on the ground, particularly if it is a hard surface such as asphalt or concrete, and grind it with a shoe or boot to extinguish the butt. The now extinguished and crushed butt is typically not picked up or otherwise retrieved, for further disposal, by the smoker. While this procedure is effective, from certain viewpoints, it is unsightly and contributes to pollution and overall environmental degradation.

Over the years, a number of devices have been developed to receive and store cigarette butts, some of which are also adaptable for use with other small litter items. One such device is described in U.S. Pat. No. 1,297,831 to Gilbert, which discloses a combination cigarette and match box package that has a space below the match box portion for receiving cigarette butts. Another such device is described in U.S. Pat. No. 2,880,775 to Beattie, which discloses a tobacco pouch having a removable liner for holding tobacco that is configured to be secured to the pouch. U.S. Pat. No. 3,090,482 to Sandacz discloses a cigarette package that has an ash receptacle on its front wall which folds outward to receive cigarette ashes. The ash receptacle is lined with metal foil and is configured to close by attaching to or being secured by the top of the cigarette package. Another device is described in U.S. Pat. No. 3,561,670 to Segal, which discloses a disposable receptacle for cigarette butts in the form of a collapsible pouch that includes an adhesive band for attaching the pouch to a support surface during use. When the receptacle is full, it is rolled or folded up and discarded with the cigarette butts inside. The receptacle is made from a two ply material having a metal foil, heat resistant inner ply and a paper outer ply. U.S. Pat. No. 5,370,138 to Mou discloses a disposable paper ashtray that has a wax coated bottom with wetted paper for extinguishing cigarette butts. U.S. Pat. No. 5,464,093 to Hogan discloses a cigarette package having an interior partitioned compartment comprising a pouch for receiving cigarette butts and other articles therein for storage and disposal. Another device is described in U.S. Pat. No. 5,522,406 to Yang, which discloses an ash tray having a disposable ash pocket with an extinguishing mechanism in the form of an inverted cone attached to the inside of the ash pocket. Yet another device is described in U.S. Pat. No. 5,992,621 to Grant, which discloses a conventional paperboard carton having two aluminum foil inner assemblies or inserts forming cylindrical tubes suitably sized for extinguishing and storing cigarette butts.

As set forth in related U.S. patent application Ser. No. 10/315,495, the present inventor has developed a new and improved pouch for extinguishing, storing and disposing of cigarette butts. This same pouch can also be used for other small articles of litter. The pouch of the aforementioned patent application has a receptacle having a front panel, a spaced apart back panel and at least one side panel to form at least one interior compartment for receiving and storing cigarette butts and other litter. In one embodiment, the receptacle is formed into at least two interior compartments by a partitioning wall or like separating device and the receptacle has opposing side panels that form a generally rectangular pouch. At least the interior side of the receptacle, facing in the interior compartment(s), is formed from a generally heat resistant, non-combustible material, such as metal or various composites. The receptacle has an open top section that opens into the interior compartment(s) and a sealed bottom to prevent cigarette butts and other litter from falling out of the receptacle. The top section has a mechanism for sealably closing the receptacle, such as a pair of top flaps with an adhesive band thereon. A protective strip can cover the adhesive band until it is desired to sealably close the pouch. The pouch also includes a mechanism to allow the smoker to extinguish the cigarette butts against the receptacle by rubbing or crushing action. In one embodiment, the extinguishing mechanism, such as one or more sheets of sandpaper or sand board material, provides rigid support for the pouch and is configured to prevent damage to the receptacle when extinguishing the cigarette butts. A non-combustible sheet can be placed between the receptacle and the extinguishing mechanism to protect the receptacle from the heat and/or rubbing or crushing action that results from extinguishing the cigarette butt. The pouch can also include a mechanism near the top section for opening the receptacle so the contents can be easily poured out into a recycling container. The opening mechanism can be a plurality of perforations placed across the top section of the receptacle.

Although the prior art and the inventor's previous patent application disclose a variety of containers and disposable ash tray devices for receiving and storing cigarette butts and other small litter, no reasonable method of distributing and collecting such containers and devices is presently known. What is needed, therefore, is a relatively low cost, effective and easy to utilize method of distributing containers, devices or other packages with the product that has a non-consumed portion which is the source of the litter (i.e., cigarettes) and collecting the packages full of the non-consumed portion of the product (i.e., the cigarette butts) for recycling. The preferred method should not add a significant cost to the product for the consumer and should include an incentive component to encourage retailers selling the product and consumers utilizing that product to participate in the recycling of the non-consumed portion thereof.

### SUMMARY OF THE INVENTION

The method of recycling cigarette butts and other small litter items of the present invention provides the benefits and solves the problems identified above. That is to say, the present invention discloses a method that includes the steps of incorporating containers, devices or other packages with a product having a non-consumable portion that is the source of the litter (i.e., cigarettes), distributing those packages from the manufacturer to distributers, retailers and consumers, collecting the packages with the non-consumed portion of the product (i.e., the cigarette butts) and then processing the packages and litter inside by the recycling or other processing company. The method of the present invention does not significantly increase the cost of the product, is relatively simple to implement and is effective at reducing the amount of litter. The method can incorporate various incentives for consumers to participate in the recycling of the non-consumed portions of the products.

In the preferred embodiment of the present invention, the method of recycling non-consumable portions of products, such as cigarette butts and other small litter items, comprises the steps of including a recycling device with the product when the product is sold by a retailer to a consumer, the consumer depositing the non-consumable portions of the product in the recycling device, the consumer presenting the recycling device with the non-consumable portions therein to a retailer when purchasing more of the product; the retailer providing a discount price to the consumer when purchasing more of the product and presenting the recycling device, and the retailer collecting and storing the recycling devices having non-consumable portions of the product therein for delivery to a recycling facility. Preferably, the recycling device is incorporated in or attached to a package for the product prior to delivery of the product to the retailer. For ease of providing the discount, the recycling device includes a discount marker having the refund amount displayed thereon. To prevent the recycling device from being used to obtain improper discounts, the discount marker should be removable from the recycling device. Alternatively, the recycling device can include alternative mechanisms for indicating that the particular recycling device has already been used to obtain a discount price. A variety of different types of recycling devices can be used with the method of the present invention. In one embodiment of the recycling device, it has a receptacle with a top section opening into at least one interior compartment, a sealed bottom, a mechanism at the top section for sealably closing the receptacle and a mechanism on the receptacle for extinguishing cigarettes and like products when rubbed or crushed against the extinguishing mechanism. The receptacle has a front panel, a spaced apart back panel and at least one side panel. An interior side in the compartment is formed from a generally heat resistant, non-combustible material.

In one embodiment of the recycling system of the present invention, a retailer entity sells a product having a recycling device associated therewith to a consumer. A consumer purchasing the product from the retailer entity consumes the consumable portion of the product and deposits the non-consumable portion of the product in the recycling device. When the consumer desires to purchase additional product, he or she presents the recycling device, preferably full of small, non-consumable portions of the product, to the retailer entity so that the retailer entity will provide a discount price to the consumer for the purchase of additional product. The product and the recycling device can be provided by a product manufacturer entity that makes the product and provided as a single unit. Alternatively, the recycling device is provided by a recycling device manufacturer separate from the product manufacturer. As above, a removable discount marker can be utilized to indicate a refund amount and to prevent multiple discounts from the same recycling device. Alternatively, other mechanisms can be utilized to indicate the refund amount and prevent unauthorized discounts. Various types of recycling devices can be utilized.

Accordingly, the primary objective of the present invention is to provide a new method of recycling cigarette butts and other small litter items, including gum wrappers, batteries, bottle tops and the like, that provides the advantages described herein and that overcomes the disadvantages associated with presently available methods of collecting such items.

It is also an important objective of the present invention to provide a method of recycling cigarette butts and other small litter items that incorporates the steps of distributing litter item collection packages to consumers with products that have a non-consumable portion and collecting such packages for recycling of the packages and content therein.

It is also an important objective of the present invention to provide a method of recycling cigarette butts and other small litter items that incorporates a package or device with a product for collecting the non-consumable portions of the product.

It is also an important objective of the present invention to provide a method of recycling cigarette butts and other small litter items that incorporates the step of providing price incentives to the consumer at the point-of-sale of a product when he or she returns a package or device for collecting the non-consumable portion of the product.

It is also an important objective of the present invention to provide a method of recycling cigarette butts and other small litter items that reduces the amount of material which is likely to be improperly disposed of as litter and reduces the amount of materials that need to be included in landfills, incinerators and other means of disposal.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a flow chart showing one aspect of the method and system of the present invention;

FIG. 2 is a flow chart showing another aspect of the method and system of the present invention;

FIG. 3 is a perspective view of a cigarette product that can be utilized with the method and system of the present invention;

FIG. 4 is a perspective view of a cigarette package that can be utilized with the method and system of the present invention;

FIG. 5 is a front side view of a recycling device suitable for use with the method and system of the present invention;

FIG. 6 is a side view of the embodiment of the recycling device of FIG. 5 with the protective strip removed; and

FIG. 7 is a back side view of the embodiment of the recycling device of FIG. 5.

### DETAILED DESCRIPTION OF THE PREFERRED EMBODIMENTS

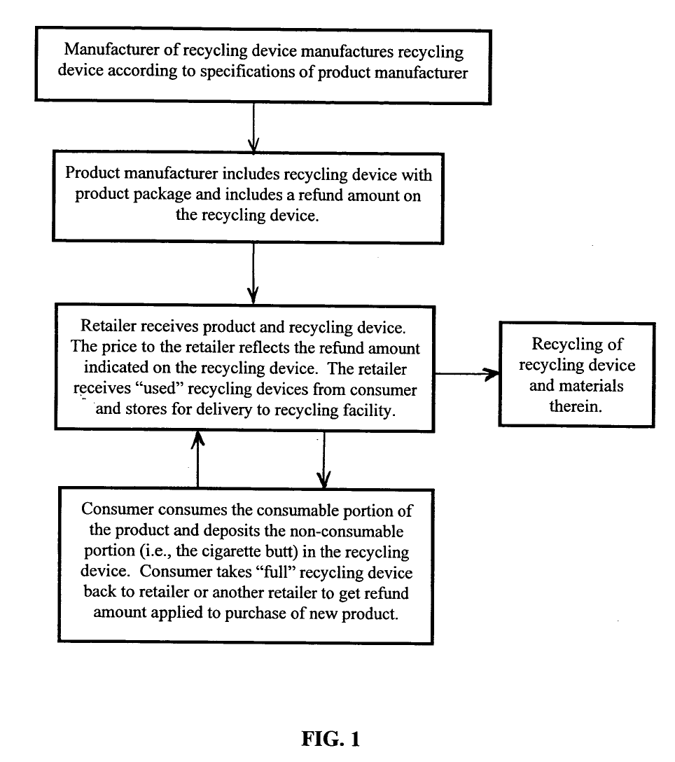

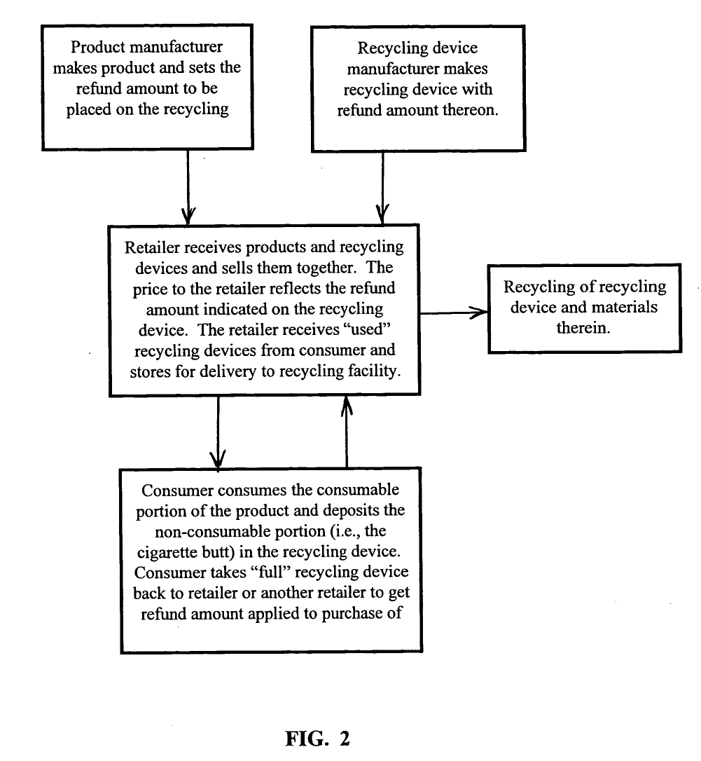

With reference to the figures where like elements have been given like numerical designations to facilitate the reader's understanding of the present invention, and particularly with reference to the embodiments of the present invention illustrated in FIGS. 1 and 2, the preferred embodiments of the present invention are set forth below. The method of the present invention, identified generally as 10 in FIGS. 1 and 2, is particularly useful for facilitating the recycling portions of products, such as cigarette 12 in FIG. 3, having a consumable portion 14 and a smaller non-consumable portion 16. Method 10 can also be utilized with other products, such as gum and bottled products having wrappers and bottle caps, that have a consumable portion and a non-consumable portion. Method 10 can also be used with batteries. With regard to cigarette 12, the consumable portion 14 generally comprises processed tobacco substantially encased in a paper cover and non-consumable portion 16 is a filter apparatus for filtering the tobacco inhaled by the consumer smoker. Although consumable portion 14 is generally fully consumed by the consumer and the non-consumable portion 16 is separately disposed of as refuse, in some circumstances some amount of the consumable portion will remain with the non-consumable portion 16 when it is disposed. For instance, with cigarette 12, it is not uncommon for non-consumed amount of cigarette 12 to include some consumable portion 14 and non-consumable portion 16. The non-consumed amount of cigarette 12 is commonly referred to as a “cigarette butt” or as just the “butt.”

Method 10 of the present invention utilizes recycling device 18, an example of which is shown in FIGS. 5 through 7 and described in more detail below, having a discount marker 20 indicating the refund value 22 for packages of product 12. Recycling device 18 is sized and configured to be provided with the packaging for product 12 and to receive and store therein one or more non-consumable portions 14. As an example, recycling device 18 may be sold with a package or carton of cigarettes 12 and be configured to receive therein one or more cigarette butts, comprising non-consumable portion 16 and some amount of consumable portion 14. In the preferred embodiment, discount marker 20 is configured such that some or all of it may be disengaged from recycling device 18 so that the amount of refund value 22 may be provided only once, as described below. To accomplish this, discount marker 20 may be configured to be removed from recycling device 18 by tearing, peeling or other action. Alternatively, discount marker 20 may include a mechanism for marking or otherwise indicating that refund value 22 has been provided for that recycling device 18. As desired, the amount of refund value 22 can be indicated by a separate mechanism, such as a label or sticker, that attaches to discount marker 20 and which is either removed from or removed with discount marker 20 to accomplish the refunded indicating objective set forth in more detail below. Refund value 22 can be selected by the product manufacturer or others based on any criteria suitable for the products and can be changed to reflect different marketing strategies. To avoid retailer backlash, the burden of the discounted price should be borne by the manufacturer, not the retailer.

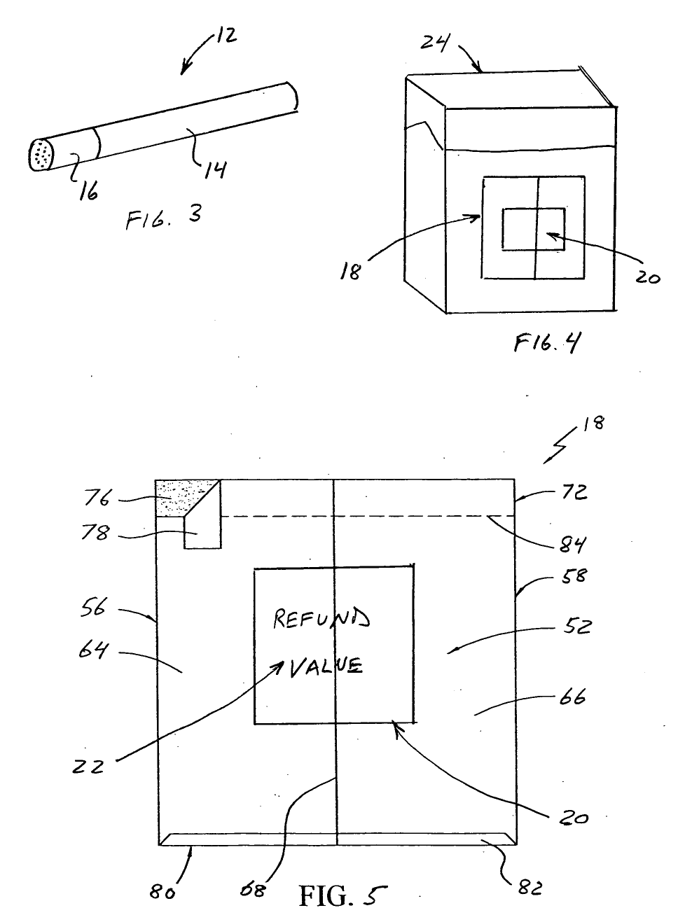

One aspect of method 10 of the present invention, shown in FIG. 1, includes step 30 through 38. In step 30, a first manufacturing entity manufactures recycling device 18 to meet the specifications and requirements of a second manufacturing entity who manufactures product 12, including any configuration and functional requirements (i.e., such as being able to extinguish cigarette butts and receive potentially hot cigarettes therein). Depending on the arrangement between manufacturing entities, the first manufacturing entity will place discount marker 20, bearing the refund value 22, on recycling device 18. For improved control and other business reasons, the second manufacturing entity may desire to place discount marker 20 on recycling device 18 itself or place refund value 22 on a previously affixed discount marker 20 (i.e., by stamping, labeling or etc.). In some circumstances, the first manufacturing entity who manufactures recycling device 18 may the same as or related to the second manufacturing entity who manufactures product 12. If they are not the same entity, the first manufacturing entity will deliver a quantity of recycling devices 18 to the second manufacturing entity. As shown in step 32, after receiving the quantity of recycling devices 18 from the first manufacturing entity the second manufacturing entity includes one or more recycling devices 18, depending on how the products are packaged (i.e., cartons of products or smaller packages), with product 12. Recycling device 18 may be inserted into or attached to the packaging, an example of which is shown as cigarette carton 24 in FIG. 4, for products 12. Alternatively, it may be included with product 12 in any fashion suitable for product 12 or desired by the manufacturing entities involved.

In the aspect of the method 10 of the present invention shown in FIG. 1, the combined product packaging 24 and recycling device 18 is delivered to a retailer entity, show in step 34. The retailer entity will sell the product packaging 24, containing products 12 and recycling device 18, to a consumer. In the preferred embodiment, the price paid by the consumer for product 12 includes recycling device 18, thereby resulting in no additional cost for the consumer. Preferably, the price paid for products 12 by the retailer entity in step 34 (i.e., the wholesale price) is reduced by the product manufacturing entity, the second manufacturing entity, to reflect the refund value 22 associated with product 12. The retailer entity will sell product 12 with recycling device 18 as it would sell any other product, except that a price discount in the amount reflected by the refund value 22 will be given to the consumer for a recycling device presented to the retailer entity by the consumer at the time he or she purchases more of product 12. The price discount on a new purchase of product 12 will only be given when a recycling device 18 having an appropriate discount marker 20 and/or other indicator of refund value 22 still on recycling device 18. When recycling device 18 is presented to the retailer entity, it will remove the discount marker and/or other refund value 22 marker to indicate that the refund for that particular recycling device 18 has been given so as to prevent multiple discounts being inappropriately provided for the same recycling device 18.

In one embodiment, the discount price is only provided for the purchase of new products 12 that are from the same manufacturer from which recycling device 18 came. For instance, if a manufacturer A manufactures brand A1 of cigarettes and manufacturer B manufactures brand B1 of cigarettes, a consumer purchasing brand A1 of cigarettes would only receive the benefit of refund value 22 if he or she is presenting the retailer entity with a recycling device 18 from brand A1. If the consumer has a recycling device 18 from brand B1 and desires to purchase brand A1, he or she will not receive the benefit of the refund value 22 associated with that recycling device 18. This approach would likely encourage brand loyalty by the consumer and would, generally, be more likely preferred by the manufactures of products 12. In another embodiment of the present invention, however, the discounted price on a purchase of like products 12 is given for presenting any recycling device 18 having a valid refund amount 22 still indicated thereon. Although this latter approach would not reward brand loyalty, it would better facilitate the objectives of reducing the amount of litter associated with the consumption of product 12. The preferred method 10 of the present invention only provides a discount towards the purchase of like goods, no independent cash value for the return of recycling device 18. In an alternative embodiment, cash could be given for the return of recycling devices 18 having non-consumable portions 16 of product 12 therein.

As set forth in step 36, the consumer would consume consumable portion 14 of product 12 in the normal fashion. After the consumer consumes all or the desired part of consumable portion 14, he or she would place the non-consumable portion 16 and any remaining consumable portion 14 (i.e., the cigarette butt) inside recycling device 18. After consuming products 12, the consumer takes recycling device 18, preferably full of cigarette butts and the like, to the retailer entity and presents it to the retailer entity when purchasing more of product 12. The retailer entity will discount the price of the new product 12 by the amount reflected by the refund value 22 on discount marker 20. The retailer entity would then remove the discount marker 20 or refund value 22 indicator or otherwise identify the recycling device 18 as having been already the subject of a refund to prevent it from being inappropriately reused. The retailer entity would collect and store the returned recycling devices 18 for transfer to a recycling facility for appropriate processing, as indicated in step 38 of FIG. 1.

In another aspect of the method 10 of the present invention, shown in FIG. 2, the product 12 is manufactured by the product manufacturer in step 40 and the recycling device 18 is manufactured by a separate manufacturer or manufacturing facility in step 42. In this aspect, the recycling device 18 is not combined with the product packaging 24 for product 12. Instead, the product manufacturer delivers the product 12 separately to the retailer entity in the manner in which such products 12 are presently delivered. As shown with step 44, the recycling device 18 is separately delivered to the retailer entity by its manufacturer. The retailer entity separately receives the products 12 and recycling devices 18 and combines them sells them as a unit to consumers. Preferably, no increase in price for recycling device 18 is paid for by the consumer such that the consumer is only paying for the products 12 and not the recycling device 18. As described above, the consumer receives a discounted price at the point-of-sale of the new product that reflects the refund value 22 on the recycling device 18 the consumer presents to the retailer entity. The consumer utilizes the recycling device 18 to collect and store cigarette butts and/or other non-consumable portions of product 12. The retailer entity will collect and store “full” or used recycling devices 18 for transfer to a recycling facility for appropriate processing.

From the foregoing, it can be determined that various benefits can be achieved by the method 10 of the present invention. Perhaps foremost among these benefits is a reduction in litter of non-consumable portions 14 of products 12, such as cigarette butts, and the recycling of those items. Currently, cigarette butts and other items, such as gum wrappers, bottle tops and batteries, end up as litter in roads, rivers, lakes, parks and other places where they do not belong. The method 10 of the present invention facilitates the prevention of litter and the recycling of items that would not otherwise be recycled and does so in a sanitary and effective manner. The reduction in litter will substantially reduce the cost of cleaning facilities where such litter ends up and in handling such litter in water treatment plants and the like. In addition, reduction of litter will reduce the impact of such litter on wildlife and improve the aesthetics of our communities. The use of recycling device 18 allows many people, from the manufacturer to the consumer, to be more involved in improving the environment. Other benefits of the method 10 of the present invention include an improvement of the environment without new taxes, governmental administration or enforcement or cost to the consumer and an opportunity for the manufacturer of such products 12 to participate in and encourage recycling of the non-consumed components of their products 12. As stated above, limiting the refund for a new product 12 to only those recycling devices that came from like products 12 of the same brand or from the same manufacturer will improve brand loyalty amongst consumers. If desired, although not preferred due to the potential reduction in other benefits, the refund amount 22 could only be given by the retailer entity who initially sold the product 12 with the recycling device 18, thereby increasing loyalty to a particular retailer. In addition, with regard to cigarettes and like products, providing appropriate recycling devices 18 will allow the consumer to safely extinguish and dispose of his or her lit cigarette butt without risk to forests, fields, buildings or other places and structures.

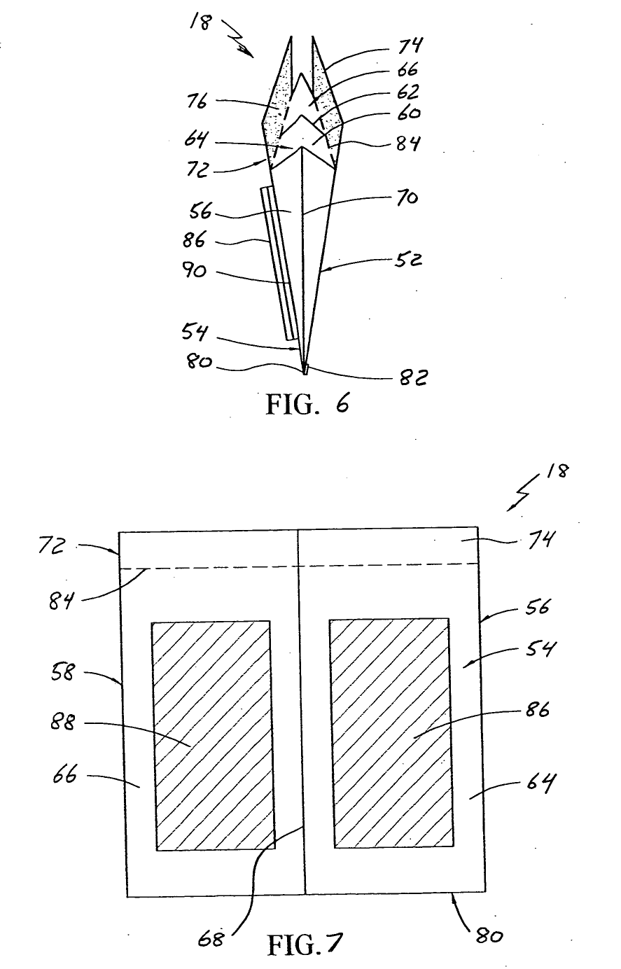

Various recycling devices 18 can be utilized with the method 10 of the present invention, including some of the prior art devices identified above. An example of such a recycling device 18, without intending to limit the method 10 of the present invention to such example, is shown in FIGS. 5 through 7. The example recycling device 18 has receptacle 50 formed from a front panel 52, a spaced apart back panel 54 and at least one side panel 56. In the preferred embodiment, receptacle 50 has opposing side panels 56 and 58 that form recycling device 18. As known to one skilled in the art, the shape of recycling device 18 can be varied (i.e., it can be square, oval, etc.). In the preferred embodiment, recycling device 18 is made from a lightweight, inexpensive material having at least an interior sides 60 (as best shown in FIG. 6) comprised of a generally heat resistant, non-combustible material, such as metal foil or various composites. The outside of recycling device 18 can be paper or other desired materials. Alternatively, a separate thin film of metallic, such as aluminum foil, or composite lining can be used to provide a non-combustible interior for recycling device 18. Use of a non-combustible interior for recycling device 18 will contain the heat from any hot or warm cigarette butts that are placed inside recycling device 18 and prevent recycling device 18 from catching on fire. In addition to providing temperature and fire protection, interior sides 60, configured as described above, will resist tearing or otherwise undesirable opening of recycling device 18 that could result in the contents being spilled.

Recycling device 18 can have a partitioning wall 62 or other mechanism to divide recycling device 18 into two or more separate interior compartments, such as first compartment 64 and second compartment 66, which are shown best in FIG. 6. Alternatively, a bead of glue or other adhesive may be used to create the interior compartments 64 and 66. Partitioning wall 62 or any other mechanism should be configured to allow recycling device 18 to be folded along fold line 68 even when recycling device 18, or individual compartments 64 or 66, are full of cigarette butts or other materials. Sides 56 and 58 comprise at least one side fold line 70 so that compartments 64 and 66 may be collapsed to as minimum profile as possible. Depending on user or manufacturer preferences, recycling device 18 can be made with one single compartment or more than the two compartments 64 and 66 shown in the figures. The use of multiple (i.e., at least two) compartments also facilitates collapsing recycling device 18 for placement inside standard cigarette packages 24 or cartons.

The top section 72 of recycling device 18 comprises a mechanism for sealably closing interior of recycling device 18 so as to close any cigarette butts inside. Top section 72 comprises a pair of opposing top flaps 74 comprising an adhesive band 76 that is normally (i.e., when not be used to seal recycling device 18) covered by a protective strip 78. Protective strip 78 can be of the type that peels off of adhesive band 76 to expose the adhesive material, such as tape, glue or other adhesives, underneath so that it may be used to sealably close top flap 74 and seal the cigarette butts and like materials inside recycling device 18. Also in the preferred embodiment, bottom 80 of recycling device 18 comprises a bottom flap 82 that is turned up onto the front side 52 (as shown in FIG. 1) or the back side 54 of recycling device 18 and sealed so as to prevent any materials inside compartments 64 and 66 from spilling or leaking out of the bottom 80 of recycling device 18.

To facilitate these recycling efforts when the contents of recycling device 18 will be processed separately from recycling device 18, top section 72 has a mechanism to facilitate the easy and sanitary emptying of recycling device 18 when it is desired to dump the contents into a container. The preferred mechanism is a plurality of perforations 84 extending from side 56 to side 58 that allow the user of recycling device 18 to tear top section 72 off of recycling device 18, thereby opening the interior of compartments 64 and 66. Alternatively, recycling device 18 can utilize various other mechanisms for opening compartments 64 and 66, such as the zipper lock or engagement types of devices used on plastic sandwich bags. As known to those skilled in the art, perforations 84 or other types of opening mechanisms should be configured such that top section 72 is not too easily torn off, resulting in inadvertent opening of compartments 64 and 66. Likewise, perforations 84 should also be configured to not be too difficult to tear across such that the user will accidently tear recycling device 18 in a place other than along perforations 84 when trying to open recycling device 18. Configured properly, perforations 84 should allow the user to tear off top section 72 and empty the contents from recycling device 18 without any undue spillage of the cigarette butts and other materials inside compartments 64 and 66.

For use with cigarettes and other smoking articles, recycling device 18 can include a mechanism for allowing the user to extinguish the cigarette butts directly on recycling device 18. The preferred mechanism is one or more pieces of sandpaper or sandpaper-like material attached to back side 54 of recycling device 18. As shown in FIG. 3, back side 54 can have a first extinguisher 86 on the outside of first compartment 64 and a second extinguisher 88 on the outside of second compartment 66. First 86 and second 88 extinguishers can be separate pieces of sandpaper affixed to recycling device 18. Alternatively, sand boards, such as Emory® boards, can be used or extinguishers 86 and 88 can be made integral with recycling device 18. Preferably, both first 86 and second 88 extinguishers are relatively rigid, as compared to the material for receptacle 50, so as to add stiffness to recycling device 18 such that when recycling device 18 is folded it can be easily slid into a cigarette packaging without damaging recycling device 18. First 86 and second 88 extinguishers should be suitable for permitting a smoker to rub or crush his or her cigarette against them so as to extinguish the cigarette butt to allow the user to safely store the butt inside compartments 64 or 66 and configured to prevent damage to receptacle 50 from the lit cigarette butt and/or the rubbing or crushing action to extinguish the cigarette butt. To help prevent heat damage from rubbing or crushing the cigarette butt out against first 86 or second 88 extinguisher or damage to the back 54 of recycling device 18 when a cigarette butt is too aggressively rubbed or crushed, recycling device 18 can utilize non-combustible sheet 90, comprising a thin strip of metallic material such as aluminum foil, or a composite material or other similar non-combustible material, disposed between back 54 and first 86 and second 88 extinguishers. Non-combustible sheet 90 can provide further stiffening to recycling device 18. First 86 and second 88 extinguishers can be placed anywhere on recycling device 18 where desired. When placed on back 14, however, recycling device 18 can be configured such that when it is folded closed, extinguishers 86 and 88 abut each other. In this manner, cigarette ash and “charcoal” is much less likely to spill from recycling device 18 or rub onto the smoker clothes (i.e., when carrying recycling device 18 in a pocket).

In use, a cigarette manufacturer or packager will include at least one recycling device 18 in each new package 24 of cigarettes 12 to encourage its consumers to safely and responsibly extinguish and dispose of cigarette butts, comprised of at least non-consumable portion 16. The packaged products 24 and recycling devices 18 are delivered, together or separately, to a retailer entity for sale to consumers. Each recycling device 18 will have a refund value 22 identified on the removable discount marker 20 or otherwise indicated such that once the refund is provided for a particular recycling device 18 it will not be given again. When the cigarette 12 is smoked down to the butt or the smoker is otherwise finished with it, he or she will unfold recycling device 18 and rub or crush the cigarette butt against first 86 and/or second 88 extinguishers to completely extinguish cigarette 12, thereby avoiding the need to rub or crush the cigarette butt against another object or on the ground. When the cigarette butt is extinguished, the consumer opens either the first 64 or second 66 compartment and drops the cigarette butt inside. Then the consumer sealably closes recycling device 18 to seal the contents therein. When the consumer is ready to purchase more products, he or she presents the recycling device 18, preferably full of cigarette butts and the like, to a retailer entity to obtain the refund amount 22 toward the purchase of more product. The retailer entity will store the recycling devices 18 presented to it in a container or other apparatus until ready for pickup by or delivery to a recycling or other processing facility. At the facility, the contents of the recycling devices 18 can be emptied, if necessary, by tearing top section 72 at perforations 84 so as to open recycling device 18. In this manner, there is no need to touch or otherwise physically handle the cigarette butts stored inside of recycling device 18.

While there are shown and described herein certain specific alternative forms of the invention, it will be readily apparent to those skilled in the art that the invention is not so limited, but is susceptible to various modifications and rearrangements in design and materials without departing from the spirit and scope of the invention. For instance, it should be noted that the present invention is subject to modification with regard to the dimensional relationships set forth herein and modifications in assembly, materials, size, shape and use. In particular, the method and system of the present invention is adaptable to a wide variety of different consumable and non-consumable products, including without limitation, cigarettes, gum, bottled products, batteries and the like.

What is claimed is:

1. A method of recycling a substantially non-consumable portion of a product, said method including the steps of:
a) including a recycling device with said product at the point-of-sale of said product to a consumer;
b) depositing one or more of said non-consumable portions of said product in said recycling device;
c) presenting said recycling device having said non-consumable portions therein to a retailer entity by said consumer when purchasing more of said product;
d) providing a discount price to said consumer purchasing more of said product and presenting said recycling device; and
e) delivering said recycling device having non-consumable portions of said product therein to a recycling facility.

2. The method of recycling according to claim 1, wherein said recycling device is incorporated in or attached to a package for said product.

3. The method of recycling according to claim 1, wherein said recycling device includes a discount marker having a refund amount thereon.

4. The method of recycling according to claim 3, wherein said discount marker is removable from said recycling device and said method further comprises the step of removing said discount marker from said recycling device after said presenting step.

5. The method of recycling according to claim 3, wherein said discount marker includes a refund value to determine said discount price for said product.

6. The method of recycling according to claim 5, wherein said recycling device includes means for establishing application of said refund value to said discount price.

7. The method of recycling according to claim 1 further comprising the step of indicating application of said recycling device to the purchase of said product after said presenting step so as to prevent further discounting based on said recycling device.

8. The method of recycling according to claim 1, wherein said recycling device includes a receptacle having a top section opening into at least one interior compartment, means at said top section for sealably closing said receptacle and means on said receptacle for extinguishing said product when said product is rubbed or crushed against said extinguishing means, said receptacle having a front panel, a spaced apart back panel and at least one side panel, said receptacle having at least an interior side in said interior compartment formed from a generally heat resistant, non-combustible material, said receptacle having a sealed bottom.

9. The method of recycling according to claim 8, wherein said extinguishing means comprises one or more pieces of sandpaper affixed to said receptacle.

10. The method of recycling according to claim 8, wherein said receptacle has at least two extinguishing means and said receptacle is configured to fold such that said extinguishing means generally abut each other.

11. A small item recycling system, comprising:
a retailer entity selling a product having a recycling device associated therewith to a consumer, said product having a consumable portion and a substantially non-consumable portion;
a consumer purchasing said product from said retailer entity and consuming said consumable portion of said product;
said consumer depositing said non-consumable portion of said product in said recycling device;
said consumer presenting said recycling device to said retailer entity; and
said retailer entity providing a discount price to said consumer for the purchase of more of said product.

12. The recycling system according to claim 11, wherein said product and said recycling device are provided by a product manufacturer entity that makes said product.

13. The recycling system according to claim 12, wherein said recycling device is incorporated in a package for said product.

14. The recycling system according to claim 11, wherein said recycling device is provided by a recycling device manufacturer separate from said product.

15. The recycling system according to claim 11, wherein said recycling device includes a discount marker having a refund amount thereon.

16. The recycling system according to claim 15, wherein said discount marker is removable from said recycling device and said second retailer entity removes said discount marker from said recycling device after providing said discount price to said consumer.

17. The recycling system according to claim 15, wherein said discount marker includes a refund value to determine said discount price for said product.

18. The recycling system according to claim 17, wherein said recycling device includes means for establishing application of said refund value to said discount price.

19. The recycling system according to claim 11, wherein the second retailer entity indicates the application of said recycling device to the purchase of said product after providing said discount price to said consumer so as to prevent further discounting based on said recycling device.

20. The recycling system according to claim 11, wherein said recycling device includes a receptacle forming at least one interior compartment, means at said top section for sealably closing said receptacle and means on said receptacle for extinguishing said product when said product is rubbed or crushed against said extinguishing means, said receptacle having a front panel, a spaced apart back panel and at least one side panel, said receptacle having at least an interior side in said interior compartment formed from a generally heat resistant, non-combustible material, said receptacle having an open top section opening into said interior compartment and a sealed bottom.

21. A small item recycling system, comprising:
a first retailer entity selling a product having a recycling device associated therewith to a consumer, said product having a consumable portion and a substantially non-consumable portion;
a consumer purchasing said product from said first retailer entity and consuming said consumable portion of said product;
said consumer depositing one or more of said non-consumable portion of said product in said recycling device;
said consumer presenting said recycling device to a second retailer entity; and
said second retailer entity providing a discount price to said consumer for the purchase more of said product.

22. The recycling system according to claim 21, wherein said product and said recycling device are provided by a product manufacturer entity that makes said product.

23. The recycling system according to claim 22, wherein said recycling device is incorporated in a package for said product.

24. The recycling system according to claim 21, wherein said recycling device is provided by a recycling device manufacturer separate from said product.

25. The recycling system according to claim 21, wherein said recycling device includes a discount marker having a refund amount thereon.

26. The recycling system according to claim 25, wherein said discount marker is removable from said recycling device and said second retailer entity removes said discount marker from said recycling device after providing said discount price to said consumer.

27. The recycling system according to claim 25, wherein said discount marker includes a refund value to determine said discount price for said product.

28. The recycling system according to claim 27, wherein said recycling device includes means for establishing application of said refund value to said discount price.

29. The recycling system according to claim 21, wherein the second retailer entity indicates the application of said recycling device to the purchase of said product after providing said discount price to said consumer so as to prevent further discounting based on said recycling device.

30. The recycling system according to claim 21, wherein said recycling device includes a receptacle forming at least one interior compartment, means at said top section for sealably closing said receptacle and means on said receptacle for extinguishing said product when said product is rubbed or crushed against said extinguishing means, said receptacle having a front panel, a spaced apart back panel and at least one side panel, said receptacle having at least an interior side in said interior compartment formed from a generally heat resistant, non-combustible material, said receptacle having an open top section opening into said interior compartment and a sealed bottom.
